(19) United States
(12) Patent Application Publication
(10) Pub. No.: US 2015/0264964 A1
(43) Pub. Date: Sep. 24, 2015

(54) NUTRITIONAL, HEALTH-BENEFICIAL, ENVIRONMENTALLY FRIENDLY CONDIMENT AND PREPARATION METHOD

(71) Applicant: Eric A. Knight, Unionville, CT (US)

(72) Inventor: Eric A. Knight, Unionville, CT (US)

(21) Appl. No.: 14/222,623

(22) Filed: Mar. 22, 2014

(51) Int. Cl. A23L 1/221; A23L 1/214

(52) U.S. Cl. CPC A23L 1/221; A23L 1/2142; A23V 2002/00

(57) ABSTRACT

Nutritional, health-beneficial, environmentally friendly condiment and preparation method that is made almost entirely from Ipomoea batatas, a root vegetable commonly known as sweet potato. No mainstream condiment has sweet potato as its primary ingredient. The invention's formulaic simplicity is also unique and unobvious. The entire sweet potato—including the root vegetable's skin—is used in the new condiment's production. Doing so imparts distinct and pleasurable flavor, texture, and color; maximizes the new condiment's nutrition and health benefits; reduces processing time, energy, and labor; and eliminates production waste.

The invention claims benefit of U.S. provisional patent application No. 61/811,133 filed on Apr. 12, 2013.

### FIELD OF THE INVENTION

The invention is in the field of nutrition. More particularly, the invention is in the field of condiments.

The field of condiments has not substantively changed in, literally, centuries.

Tomato-based ketchup was invented in America in the early 1800s.

Mayonnaise was invented in 1756 in France.

Mustard was invented by the Romans in late 4th or early 5th century.

Remarkably, there have been no widely adopted sauce-type condiments invented since.

Other, less-popular, sauce-type condiments are simply blends of other ingredients. For instance, “horseradish sauce” is grated horseradish root combined with mayonnaise.

Ketchup, mayonnaise, and mustard were all invented prior to the modern era's focus on health and nutrition. Many store-bought condiment types and brands are replete with fat, cholesterol, sodium, sugar, corn starch, sodium benzoate, soybean oil, high fructose corn syrup, xanithan gum, lactic acid, phosphoric acid, potassium sorbate, monosodium glutamate, sorbic acid, other preservatives, colorings, flavorings, and artificial ingredients. These condiments are far from healthy or nutritional.

Current sauce-based condiments typically create significant waste products during production.

In the production of mayonnaise, the shells of the required egg ingredient are thrown away.

In the production of ketchup, tomato seeds and tomato skins are discarded.

In the production of mustard, crushed mustard seeds are passed through sieves to remove hulls and bran; the hulls and bran are discarded.

General Overview of the Invention

The invention is a healthy, nutritional, sauce-type condiment. It overcomes all of the stated disadvantages of the prior art.

It is a unique, new, nutritious, and healthy condiment that is produced without waste during its manufacturing.

World's First Condiment Made Almost Entirely from a Root Vegetable

The invention's primary ingredient is Ipomoea batatas, a root vegetable commonly known as sweet potato. No other condiment has sweet potato as its primary ingredient.

In fact, the invention can be considered the world's first condiment made almost entirely from a root vegetable.

Invention Contains Only One Solid Organic Ingredient

Moreover, not only is sweet potato the primary ingredient, it is the sole non-liquid organic component. There is no other mainstream condiment, invented in the last couple hundred years, that has a similarly fundamental and pure core ingredient.

Furthermore, its formulaic simplicity is unique and unobvious, in and of itself.

The new condiment is brought to life by a unique and unobvious preparation method that imparts unique and unobvious health, flavor, environmental, processing, production, and energy benefits.

Other than washing the sweet potatoes, for sanitary reasons, no other pre-preparation (such as skinning) is required. The entire sweet potato—including the root vegetable's skin—is used in the new condiment's production. Doing so imparts distinct and pleasurable flavor, texture, and color; maximizes the new condiment's nutrition and health benefits; reduces processing time, energy, and labor; and eliminates production waste.

Additionally, according to the North Carolina Sweep Potato Commission, sweet potato skins are a good source of the anti-oxidant beta carotene, a precursor of Vitamin A; Vitamin A supports healthy skin and mucus membranes, vision and eye health, and the immune system in general.

The skin of the sweet potato is also high in dietary fiber, supporting digestive health. The fiber content also contributes to a sense of “fullness”—and thus may be helpful as a dieting aid.

By the 100% utilization of the skin of a sweet potato in the invention, maximum health benefits are imparted to the condiment—and, ultimately, to the consumer.

The new condiment excels in other ways, too. Unlike other condiments, the new condiment has essentially zero fat, zero cholesterol, and no added sweeteners.

The new condiment is also self-preserved due to the acidic environment imparted by the vinegar component. No artificial preservatives are thus required.

The new condiment is extremely versatile:

Unlike other condiments that are typically used for select food groups, the new condiment has been found to be an appealing addition to a wide range of foods—including hamburgers, cheeseburgers, hot dogs, French fries, sandwich steaks, cold-cut sandwiches, crab cakes, fish fillets, chicken wings, and more.

The new condiment can also be used as a chip dip, grilling marinade, baking coating for fish, dipping sauce for salad sticks, and dipping sauce for shrimp. The new condiment can also be used as a dressing for salads.

The new condiment has also been found to be a delicious, non-fat substitute for butter on corn, in mashed potatoes, and elsewhere that butter is typically applied.

New uses of the invention are continually being discovered by the inventor.

In short: The invention is the ideal, versatile condiment and multi-food supplement for today's health-conscious society. And because it is produced without waste products, it is the only condiment that can be said to be entirely environmentally friendly.

### BRIEF DESCRIPTION OF THE DRAWINGS

FIG. 1. is a flow chart that depicts the preparation of an embodiment of the invention.

FIG. 2. is a flow chart that depicts the preparation of another embodiment of the invention.

FIG. 3. is a flow chart that depicts the preparation of another embodiment of the invention.

FIG. 4. is a flow chart that depicts the preparation of another embodiment of the invention.

### DETAILED DESCRIPTIONS AND PREPARATION OF THE INVENTION

The disclosed, new sauce-based condiment is unique in many ways.

No other condiment has as its primary ingredient Ipomoea batatas—commonly known as the sweet potato. In fact, due to a unique processing method, no other vegetables or other significant organic ingredient is required to fully enable the invention.

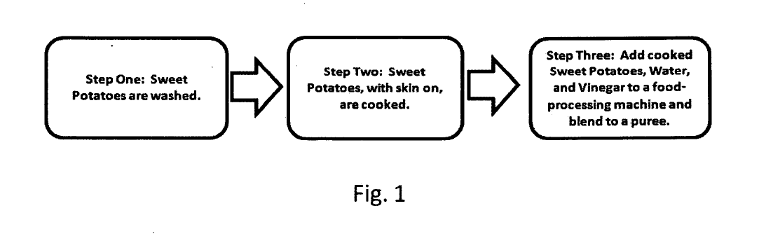

Referring to FIG. 1, a fully enabled version of the invention can be accomplished in as little as three steps with only three ingredients: sweet potato, water, and vinegar.

In this example embodiment, the following proportional ingredients (by volume) are applied:

256 units Sweet Potato

290 units Water

10 units Vinegar

Step One: Sweet Potatoes are washed.

Step Two: Sweet Potatoes, with skin on, are cooked.

Step Three: The cooked Sweet Potatoes, Water, and Vinegar are added to a food-processing machine and blended to a puree.

Through this simple process, the resulting new condiment can be used immediately.

Further regarding Step Two, cooking the sweet potatoes with the skin on:

There are many health-related virtues of the skin of a sweet potato. As mentioned previously in this invention disclosure, utilizing the vegetable's skin maximizes the new condiment's nutrition and health benefits; imparts a distinct flavor, texture, and color; reduces processing time, energy, and labor; and eliminates production waste. The result is a unique and unobvious invention with many important benefits.

Further regarding the vinegar ingredient:

It should be noted that various vinegar types can be applied in the disclosed three-ingredient formula. White vinegar provides a neutral flavoring. There are also many intrinsically flavorful vinegars—such as, but not limited to, apple cider vinegar, wine vinegar, balsamic vinegar, rice vinegar, malt vinegar, black fig vinegar, cane vinegar, beer vinegar, coconut vinegar, raisin vinegar, and sherry vinegar—that impart wonderful supplemental flavorings to the invention. Those skilled in the art of food preparation will undoubtedly imagine many vinegar variations and combinations, all of such are within the spirit and scope of the invention.

Another important note regarding the vinegar ingredient: Proportions of vinegar to the overall mixture can vary substantially to tailor the resulting invention to a desired taste.

In addition to providing a flavoring component, vinegar also functions as a preservative element in the invention. Vinegar is an acidic fluid, and can create an intolerable environment for many harmful bacteria. Proportions of vinegar to the overall mixture can vary substantially to tailor the resulting bacteria-inhibiting/bacteria-killing characteristics.

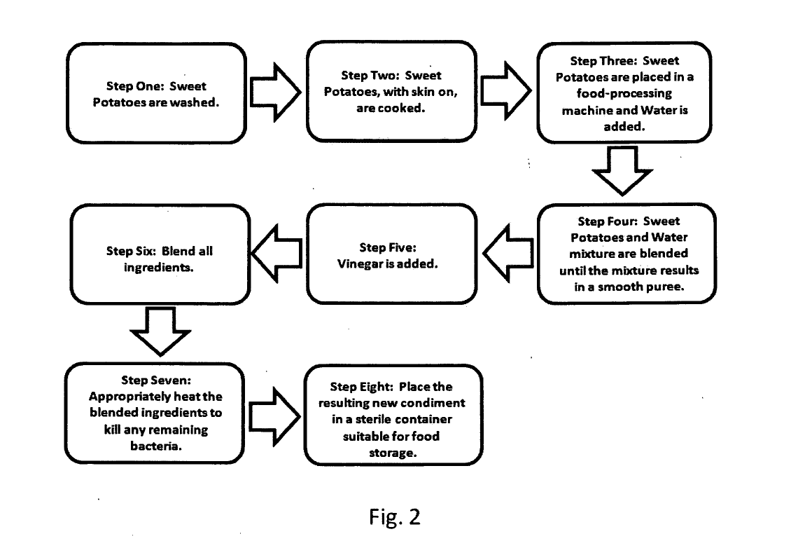

Referring to FIG. 2, the preparation of another example embodiment of the invention is shown.

The following proportional ingredients (by volume) are applied:

256 units Sweet Potato

290 units Water

10 units Vinegar

The steps applied:

Step One: Sweet Potatoes are washed.

Step Two: Sweet Potatoes, with skin on, are cooked.

Step Three: Sweet Potatoes are placed in a food-processing machine and Water is added.

Step Four: Sweet Potatoes and Water mixture are blended until the mixture results in a smooth puree.

Step Five: Vinegar is added.

Step Six: Blend all ingredients.

Step Seven: Appropriately heat the blended ingredients to kill any remaining bacteria.

Step Eight: Place the resulting new condiment in a sterile container suitable for food storage.

As mentioned previously, a variety of vinegar types can be applied, depending largely on the preparer's flavor preferences for the new condiment.

Also, as mentioned previously, the proportional quantity of vinegar applied can vary substantially, both to emphasis/de-emphasize the vinegar's flavor contribution and to modulate the bacteria-inhibiting/bacteria-killing properties imparted to the invention by the acidity of the vinegar.

Further regarding Step Seven, heating to kill any remaining bacteria:

The precise temperature and duration to neutralize the bacteria will primarily vary depending upon the cooking vessels, cooking pressures, container sizes, and general apparatus. It should be noted that an alternate and/or supplemental, and perfectly reasonable, bacteria-inhibiting/bacteria-killing process would be to heat the new condiment after it has been packaged. This technique is commonly used in mass food production, and may be applied in the production of the new condiment as well, as described elsewhere in this disclosure.

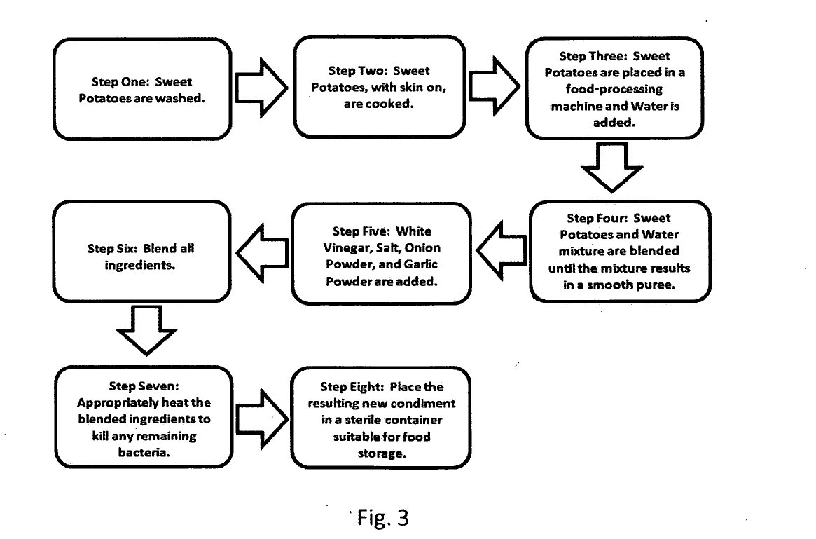

FIG. 3. illustrates the preparation of another example embodiment of the invention.

The following proportional ingredients (by volume) are applied:

1 unit Garlic Powder

2 units Onion Powder

4 units Salt

10 units White Vinegar

256 units Sweet Potato

290 units Water

The steps applied:

Step One: Sweet Potatoes are washed.

Step Two: Sweet Potatoes, with skin on, are cooked.

Step Three: Sweet Potatoes are placed in a food-processing machine and Water is added.

Step Four: Sweet Potatoes and Water mixture are blended until the mixture results in a smooth puree.

Step Five: White Vinegar, Salt, Onion Powder, and Garlic Powder are added.

Step Six: Blend all ingredients.

Step Seven: Appropriately heat the blended ingredients to kill any remaining bacteria.

Step Eight: Place the resulting new condiment in a sterile container suitable for food storage.

This particular embodiment describes a variation in which a particular type of vinegar is selected and applied (White Vinegar), as well as two spices added (Garlic Powder and Onion Powder), as well as Salt being included. The types and quantities of vinegar and spices, as well as the use and amount of salt, are simply illustrative of the many combinations of supplemental ingredients appropriate for consideration and use—the myriad of which are within the spirit and scope of the invention.

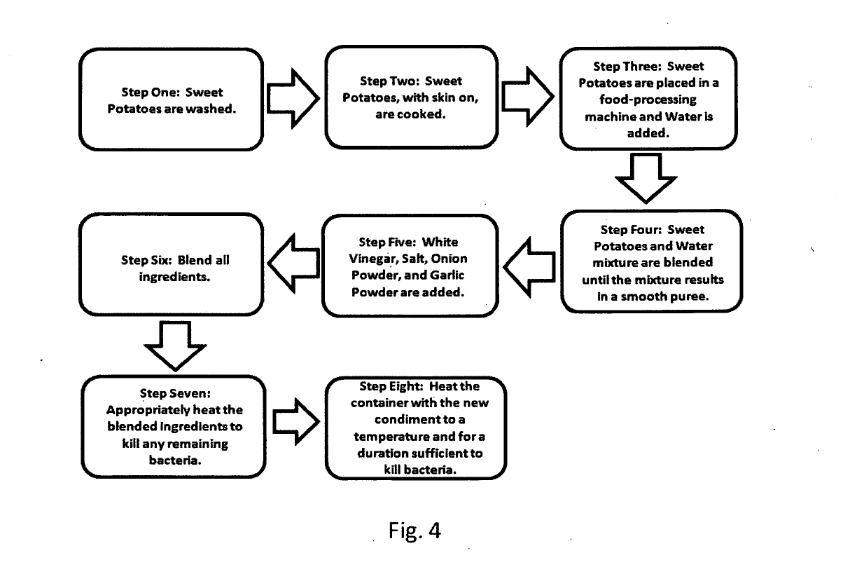

The example preparation method illustrated by FIG. 4 is similar to the example preparation steps of FIG. 3, with the primary exception that the heating of the new condiment to kill harmful bacteria occurs after the product is packaged.

It is important to note that both of the described heating-to-kill-bacteria techniques—pre-containerizing of FIG. 3 and post-containerizing of FIG. 4—can be used together in the preparation of the invention.

Intrinsic Shelf Life:

Research and testing are ongoing to determine the new condiment's shelf life. When refrigerated, the new condiment has shown to remain perfectly viable for many months. Without refrigeration, as long as the product has been prepared with heat-based bacterial-killing processes, as generically described herein, the new condiment has also shown many-month viability.

Extension of Shelf Life:

Should it be desired, shelf life could be maximized through the addition of preservatives—such as butylated hydroxyanisole (BHA) and butylated hydroxytoluene (BHT)—that are used in other comparable food types. The addition of one or more preservatives is a reasonable supplementation to the basic formula and preparation, and is within the spirit and scope of the invention.

For a broad reference, a list of popular food preservatives include: acetic acid, ascorbic acid, calcium ascorbate, erythorbic acid, iso-ascorbic acid, potassium nitrate, potassium nitrite, sodium ascorbate, sodium erythorbate, sodium iso-ascorbate, sodium nitrate, sodium nitrite, wood smoke, benzoic acid, calcium sorbate, carnobacterium maltaromaticumCB1,4-hexylresorcinol, methyl-ρ-hydroxy benzoate, methyl paraben, potassium benzoate, potassium bisulphite, potassium lactate, potassium metabisulphite, potassium sorbate, propyl-ρ-hydroxy benzoate, propyl paraben, sodium acetate, sodium benzoate, sodium bisulphite, sodium diacetate, sodium lactate, sodium metabisulphite, sodium salt of methyl-ρ-hydroxy benzoic acid, sodium salt of propyl-ρ-hydroxy benzoic acid, sodium sorbate, sodium sulphite, sodium dithionite, sorbic acid, sulphurous acid, calcium propionate, calcium sorbate, dimethyl dicarbonate, natamycin, potassium sorbate, propionic acid, sodium diacetate, sodium propionate, sodium sorbate, sorbic acid, ascorbic acid, ascorbyl palmitate, ascorbyl stearate, butylated hydroxyanisole (a mixture of 2-tertiarybutyl-4-hydroxyanisole and 3-tertiarybutyl-4-hydroxyanisole), butylated hydroxytoluene (3,5-diternarybutyl-4-hydroxytoluene), citric acid, citric acid esters of mono- and diglycerides, L-cysteine, L-cysteine hydrochloride, gum guaiacum, lecithin, lecithin citrate, monoglyceride citrate, monoisopropyl citrate, propyl gallate, tartaric acid, tertiary butyl hydroquinone, and tocopherols (alpha-tocopherol; tocopherols concentrate, mixed).

Spices and Seasonings:

Almost all food preparations include spices to modify or enhance fundamental flavors. In the invention, some embodiments includes garlic powder and onion powder. Although specific spices and seasonings have been disclosed to illustrate some embodiments, many other reasonable spices and seasonings can be considered and applied to suit preferred tastes, textures, colorations, and consistencies. For instance, a “hot” version of the new condiment has been developed that includes the spice called cayenne pepper. Seasoning modifications, as such, are certainly within the spirit and scope of the invention. In fact, the entire spectrum of food spices can be considered for use with the invention.

For additional reference, a list of some popular food spices includes: Allspice (Pimento), Anise Seed, Star Anise, Balm (Lemon Balm), Basil Leaves (Sweet), Bay Leaves (Laurel Leaves), Black Caraway (Russian Caraway, Black Cumin), Camomile (English or Roman), Camomile (German or Hungarian), Capsicums, Caraway Seed, Cardamom, Cassia/Cinnamon, Cayenne Pepper (Red Pepper), Celery Seed, Chervil, Chives, Cilantro (Coriander Leaf), Cinnamon/Cassia, Cloves, Coriander Seed, Cumin Seed (Cummin), Dill Seed, Dill Weed, Fennel Seed, Fenugreek Seed (Foenugreek Seed), Galangal, Ginger, Horseradish, Juniper, Lavender, Mace, Marjoram Leaves, Mustard Seed, Nutmeg, Oregano Leaves, Paprika, Parsley (Dehydrated Parsley, Parsley Flakes), Black Pepper, White Pepper, Green Peppercorns, Pink Peppercorns, Peppermint Leaves (Peppermint Flakes), Poppy Seed, Rosemary Leaves, Sage Leaves, Savory Leaves, Sesame Seed, Spearmint Leaves (Spearmint Flakes), Tarragon Leaves, Thyme Leaves, Vanilla Bean, Garlic, Onion, Annatto Seed, Saffron, and Turmeric.

Salt:

Salt is the world's most popular food additive. Similar to spices, this mineral is used to modify or enhance the fundamental flavors of food. It also offers food-preservative properties.

Salt is included in some embodiments of the invention. However, it may be prepared without salt or with minimal salt to provide a no-salt or low-salt condiment for taste preference, for those on dietary restrictions, etc. The use, reduction, or elimination of salt in the condiment formula is certainly within the spirit and scope of the invention.

Other Additives:

The invention's fundamental formula is provided in a simplistic form herein, to provide a straightforward example of preparation. It should be recognized, however, that those skilled in the art of food preparation will likely apply their own skills and culinary inspirations to this baseline formula.

For instance, even though the presented embodiment results in an essentially smooth, homogenous product, granular food elements may be added to provide variations in taste, texture, nutrition, color, etc. For example, minced vegetables, fruits, nuts, grains, etc., could be applied to the baseline formula and still be within the spirit and scope of the invention.

Similarly, dairy products—such as milk and cheese—could be applied to the core formula and still remain within the spirit and scope of the invention.

The intrinsic color of the invention has been found to be quite pleasing to product testers. However, the addition of food colorings (via natural and/or synthetic additives) to modify the invention's intrinsic color is within the spirit and scope of the invention.

Proportional Formula Variations:

It should be noted that although precise proportional formulas have been disclosed to prepare the example embodiments, many other reasonable proportional formulations can be considered and applied to suit preferred tastes, textures, colorations, and consistencies. These formulation modifications are within the spirit and scope of the invention.

Regarding the Order of Preparation Steps:

The steps indicated in FIG. 1-FIG. 4, and described further herein, should not be taken as absolute, but only as guidelines as to a few example preparation methods. Comparable and entirely reasonable versions of the new condiment can be created if the step-order is altered and/or some steps are combined. For instance, the three-step process illustrated by FIG. 1 and the first six steps illustrated by FIG. 2 produce comparable end results.

Step alterations and variations, as such, are reasonable adjustments to the underlying formula and preparation, and are within the spirit and scope of the invention.

Overall, this invention disclosure was written in a granular way to provide an optimum understanding of the underlying invention. Those skilled in the art of food processing and preparation will recognize various combinations and alterations of the disclosed ingredients and methods that are nonetheless within the spirit and scope of the invention.

Health Benefits of the Invention

The health benefits of the invention cannot be overstated. As described, central to the new condiment is Ipomoea batatas—a root vegetable otherwise known as sweet potato.

Sweet potatoes are rich in dietary fiber, complex carbohydrates, beta carotene (a “vitamin A” nutrient), vitamin C, and vitamin B6. This root vegetable has also been shown to help control diabetes.

“In 1992, the Center for Science in the Public Interest compared the nutritional value of sweet potatoes to other vegetables. Considering fiber content, complex carbohydrates, protein, vitamins A and C, iron, and calcium, the sweet potato ranked highest in nutritional value. According to these criteria, sweet potatoes earned 184 points, 100 points over the next on the list, the common potato.” [Source: Wayne Bailey Produce Company]

“Orange-fleshed sweet potatoes may be one of nature's unsurpassed sources of beta-carotene. Several recent studies have shown the superior ability of sweet potatoes to raise our blood levels of vitamin A. This benefit may be particularly true for children. In several studies from Africa, sweet potatoes were found to contain between 100-1,600 micrograms (RAE) of vitamin A in every 3.5 ounces—enough, on average, to meet 35% of all vitamin A needs, and in many cases enough to meet over 90% of vitamin A needs (from this single food alone).” [Source: The George Mateljan Foundation]

“Despite the name ‘sweet,’ it may be a beneficial food for diabetics, as preliminary studies on animals have revealed it helps to stabilize blood sugar levels and to lower insulin resistance.” [Source: Agrofood Company]

“The glycemic index of sweet potatoes is a lot lower [than white potatoes], which is better for diabetes control, according to a 2002 article in the ‘American Journal of Clinical Nutrition.’ Eating sweet potatoes in moderate amounts will help you keep your blood sugar levels in the healthy range even if you have diabetes.” [Source: Healthy Eating, Hearst Communications Inc.]

“Anthocyanin and other color-related pigments in sweet potato are equally valuable for their anti-inflammatory health benefits. In the case of inflammation, scientists understand even more about the amazing properties of this tuber. In animal studies, activation of nuclear factor-kappa B (NF-kB); activation of inducible nitric oxide synthase (iNOS), and cyclooxygenase-2 (COX-2); and formation of malondialdehyde (MDA) have all be shown to get reduced following consumption of either sweet potato or its color-containing extracts. Since each of these events can play a key role in the development of unwanted inflammation, their reduction by sweet potato phytonutrients marks a clear role for this food in inflammation-related health problems. In animal studies, reduced inflammation following sweet potato consumption has been shown in brain tissue and nerve tissue throughout the body.” [Source: The George Mateljan Foundation]

The invention's formulation and preparation have been carefully designed to maintain as much of the nutritional value of the sweet potato as possible.

While the foregoing written description of the invention enables one of ordinary skill to make and use the invention, those of ordinary skill will understand and appreciate the existence of variations, combinations, and equivalents of the specific embodiments, methods, and examples herein. The invention should therefore not be limited by the above described embodiments, methods, and examples, but by all embodiments and methods within the spirit and scope of the invention.

1-27. (canceled)

28. A nutritious, sauce-type condiment created without production waste comprising a mixture of
pureed whole, with-skin, cooked Ipomoea batatas root vegetables, comprising approximately 25% to 85% of the total volume of said mixture,
water, comprising approximately 15% to 75% of the total volume of said mixture, and
vinegar, comprising approximately 0.5% to 4% of the total volume of said mixture.

29. The condiment of claim 28 wherein said mixture further including at least one food additive selected from the group consisting of salt, non-salt spice, vegetable, fruit, grain, nut, dairy product, food coloring, and food preservative.

30. The condiment of claim 29 wherein said salt comprising approximately 0.01% to 2% of the total volume of said mixture.

31. The condiment of claim 29 wherein said non-salt spice comprising approximately 0.01% to 2% of the total volume of said mixture.

32. The condiment of claim 29 wherein said vegetable comprising approximately 1% to 25% of the total volume of said mixture.

33. The condiment of claim 29 wherein said fruit comprising approximately 1% to 25% of the total volume of said mixture.

34. The condiment of claim 29 wherein said grain comprising approximately 1% to 25% of the total volume of said mixture.

35. The condiment of claim 29 wherein said nut comprising approximately 1% to 25% of the total volume of said mixture.

36. The condiment of claim 29 wherein said dairy product comprising approximately 1% to 25% of the total volume of said mixture.
